(19) United States
(12) Patent Application Publication
(10) Pub. No.: US 2010/0085288 A1
(43) Pub. Date: Apr. 8, 2010

(54) Liquid crystal display device and flicker prevention method for a liquid crystal display device

(75) Inventor: Fumihiko Kato, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/585,338

(22) Filed: Sep. 11, 2009

(30) Foreign Application Priority Data
Oct. 3, 2008 (JP) 2008-258026

(51) Int. Cl. G09G 3/36

(52) U.S. Cl. 345/87

(57) ABSTRACT

Provided is a liquid crystal display device including: an image signal line drive unit that supplies an image voltage depending on an output image to a plurality of image signal lines set in a matrix pattern on a liquid crystal panel constituted of a plurality of pixels; an offset direction detection unit that detects offset directions of offset voltages on the plurality of image signal lines; and an offset direction combination unit that collectively combines the offset directions of the offset voltages of the plurality of image signal lines into one direction based on the offset directions.

### BACKGROUND

1. Field of the Invention

The present invention relates to a technique of preventing a flicker on a screen in a liquid crystal display device.

2. Description of Related Art

In recent years, liquid crystal display devices are being widely used in various products such as a liquid crystal television and a mobile phone. The liquid crystal display devices are required to have high quality. In particular, a technique of preventing a flicker is being demanded to be improved.

A liquid crystal display device is provided with a unit that applies, to a plurality of pixels that constitute a liquid crystal panel, a voltage depending on an image to be displayed. The unit is called a drain driver, a gate driver, or the like, and is constituted of a plurality of image signal line drive units that supply a desired image voltage for each image signal line set in a matrix pattern in the liquid crystal panel.

The flicker is generated due to a variation (output deviation) of voltage values supplied to a liquid crystal panel, and the output deviation is caused due to a characteristic difference among offset voltages that vary by image signal line. The offset voltage is generated due to a quality difference or the like of semiconductor devices used for the respective image signal line drive units, and is therefore generated at random for each image signal line. That is, an offset direction may be a positive direction or a negative direction depending on each of the image signal lines. In this way, the characteristic difference among the offset voltages causes the output deviation, leading to the generation of the flicker.

The invention disclosed in Japanese Unexamined Patent Application Publication No. 11-249623 copes with the problem mentioned above. That is, from each of a plurality of amplifier circuits that outputs an image signal voltages to each image signal line, an image signal voltage obtained by adding an offset voltage to an input image signal or an image signal voltage obtained by subtracting the offset voltage from the input image signal is output for each predetermined cycle, and the image signal voltage obtained by being subjected to the addition or subtraction of the offset voltage with respect to the input image signal is alternately output every n frames from each of the amplifier circuits.

### SUMMARY

The present inventor has found a problem in the configuration disclosed in Japanese Unexamined Patent Application Publication No. 11-249623. There is the problem in that cancellation between frames may increase the output deviation by the offset voltages because a positive light transmittance and a negative light transmittance are different in actuality.

To solve the above-mentioned problem, a first exemplary aspect of the present invention is a liquid crystal display device including: an image signal line drive unit that supplies an image voltage depending on an output image to a plurality of image signal lines set in a matrix pattern on a liquid crystal panel constituted of a plurality of pixels; an offset direction detection unit that detects offset directions of offset voltages on the plurality of image signal lines; and an offset direction combination unit that collectively combines the offset directions of the offset voltages of the plurality of image signal lines into one direction based on the offset directions.

A second exemplary aspect of the present invention is a flicker prevention method for a liquid crystal display device, including: detecting offset directions of offset voltages on a plurality of image signal lines which are set in a matrix pattern on a liquid crystal panel constituted of a plurality of pixels, and to which an image voltage depending on an output image is supplied; and combining the offset directions of the offset voltages of all the image signal lines into the same direction based on the offset directions.

According to the above-mentioned aspects, the offset voltages are entirely combined in the same direction before the offset voltages are output to each of the image signals line. For example, the offset voltages that are output from a drain driver to each of the drain signal lines are combined in the positive direction or in the negative direction. Thus, it is possible to hold the output deviation on the liquid crystal panel below half that of related art, with the result that the flicker can be effectively prevented.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a diagram showing a basic structure of a liquid crystal display device according to the present invention;

FIG. 2 is a diagram showing a structure of the drain driver according to a first embodiment of the present invention;

FIG. 3 is a diagram showing a structure of an offset voltage control output circuit according to the first embodiment;

FIG. 4 is a diagram showing a structure of an output buffer according to the first embodiment;

FIG. 5 is a timing chart in a liquid crystal display device according to the first embodiment;

FIG. 6 is a diagram showing a structure of an offset voltage control output circuit according to a second embodiment of the present invention;

FIG. 7 is a timing chart in a liquid crystal display device according to the second embodiment;

FIG. 8 is a diagram showing a structure of an offset voltage control output circuit according to a third embodiment of the present invention;

FIG. 9 is a diagram showing a structure of an output buffer according to the third embodiment; and

FIG. 10 is a timing chart in a liquid crystal display device according to the third embodiment.

### DETAILED DESCRIPTION OF THE EXEMPLARY EMBODIMENTS

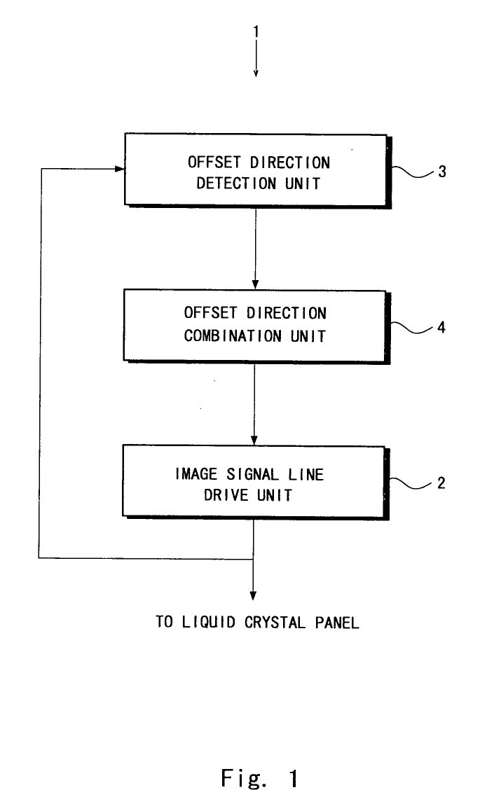

FIG. 1 shows a basic structure of a liquid crystal display device 1 according to the present invention. The liquid crystal display device 1 includes an image signal line drive unit 2, an offset direction detection unit 3, and an offset direction combination unit 4. The image signal line drive unit 2 supplies an image voltage depending on an output image to a plurality of image signal lines set in a matrix pattern on a liquid crystal panel constituted of a plurality of pixels. The offset direction detection unit 3 detects an offset direction of an offset voltage on each of the image signal lines. The offset direction combination unit 4 combines offset directions of the offset voltages of all the image signal lines into the same direction based on the offset direction detected by the offset direction detection unit 3.

By using the liquid crystal display device 1 according to the present invention, the offset voltages are entirely combined in the same direction before output from the image signal lines. For example, the offset voltages that are output from the drain driver to each of the drain signal lines are combined in the positive direction or in the negative direction. Thus, it is possible to hold an output deviation on the liquid crystal panel below half that of related art, with the result that a flicker can be effectively prevented.

Hereinafter, embodiments of the present invention will be described more specifically. It should be noted that, in different embodiments, portions that exert the same or similar effect are denoted by the same reference numerals or symbols and their descriptions will be omitted.

First Embodiment

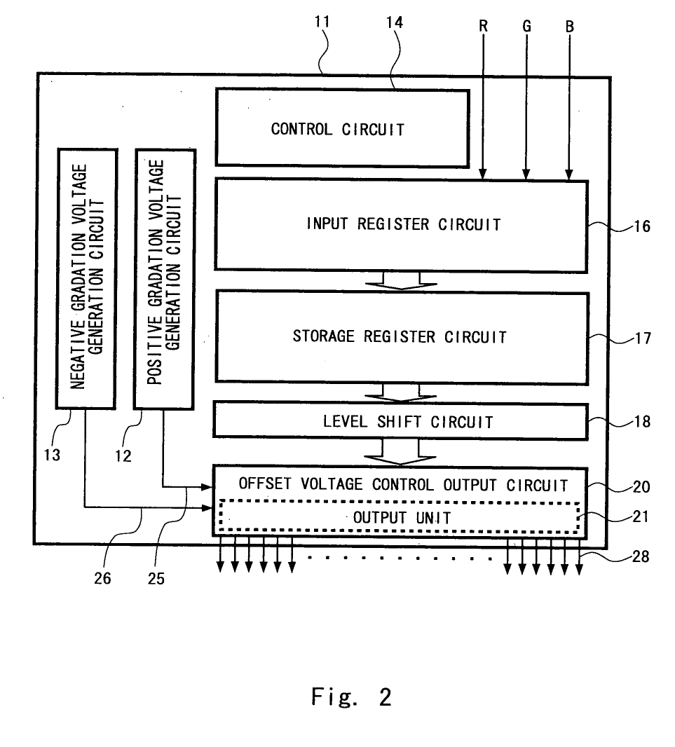

FIG. 2 shows a structure of a drain driver 11 according to this embodiment. The drain driver 11 includes a positive gradation voltage generation circuit 12, a negative gradation voltage generation circuit 13, a control circuit 14, an input register circuit 16, a storage register circuit 17, a level shift circuit 18, and an offset voltage control output circuit 20, and is formed of one semiconductor integrated circuit.

The positive gradation voltage generation circuit 12 generates gradation voltages of 64 gradations based on positive gradation reference voltages of 5 values, and the gradation voltages generated are output to the offset voltage control output circuit 20 via a voltage bus line 25.

The negative gradation voltage generation circuit 13 generates gradation voltages of 64 gradations based on negative gradation reference voltages of 5 values, and the gradation voltages generated are output to the offset voltage control output circuit 20 via a voltage bus line 26.

A shift register circuit in the control circuit 14 generates a data load signal and outputs the signal to the input register circuit 16. The input register circuit 16 latches 6-bit display data of each color by the number of outputs based on the data load signal that is output from the shift register circuit in the control circuit 14.

The storage register circuit 17 latches display data in the input register circuit 16.

The display data loaded in the storage register circuit 17 is input to the offset voltage control output circuit 20 via the level shift circuit 18.

An output unit 21 of the offset voltage control output circuit 20 selects one gradation voltage (one gradation voltage out of 64 gradations) that corresponds to an output image based on the positive gradation voltages of 64 gradations or the negative gradation voltages of 64 gradations, and outputs the selected gradation voltage to each drain signal line 28.

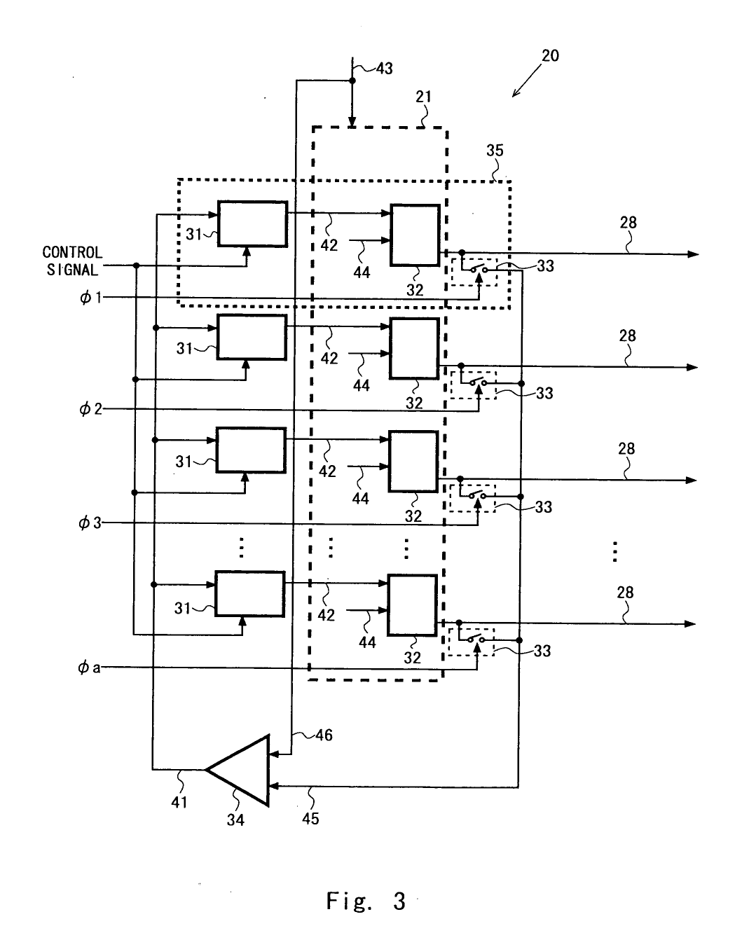

Further, the offset voltage control output circuit 20 has a function of controlling the offset voltage that causes the flicker. The offset voltage control output circuit 20 shown in FIG. 3 includes differential switch signal output devices 31, output buffers 32, output selector switches 33, and a comparator 34.

The differential switch signal output device 31 receives a control signal from the control circuit 14 (see, FIG. 2) and stores differential switch reference information 41 obtained from the comparator 34.

The output buffer 32 receives a differential switch signal 42 output from the differential switch signal output device 31 and a gradation voltage signal 44 generated based on an image gradation voltage 43 that is output from the negative gradation voltage generation circuit 13, and outputs a drain signal to the liquid crystal panel via the drain signal lines 28. The output unit 21 (see, FIG. 2) is constituted of a plurality of output buffers 32.

One end of the output selector switch 33 is connected to the drain signal line 28, and the other end thereof is connected to the comparator 34. When control signals φ1, φ2, φ3, . . . , φ a that are output from the control circuit 14 are “H”, the output selector switch 33 is ON, and when those control signals are “L”, the output selector switch 33 is OFF.

A part constituted of the differential switch signal output device 31, the output buffer 32, and the output selector switch 33 is referred to as a drain signal line drive block 35 (image signal line drive unit).

The comparator 34 receives the drain signal that is output from the output buffer 32 via the output selector switch 33 as a compared voltage 45 and the image gradation voltage 43 as a reference voltage 46, and outputs the differential switch reference information 41 to the differential switch signal output device 31.

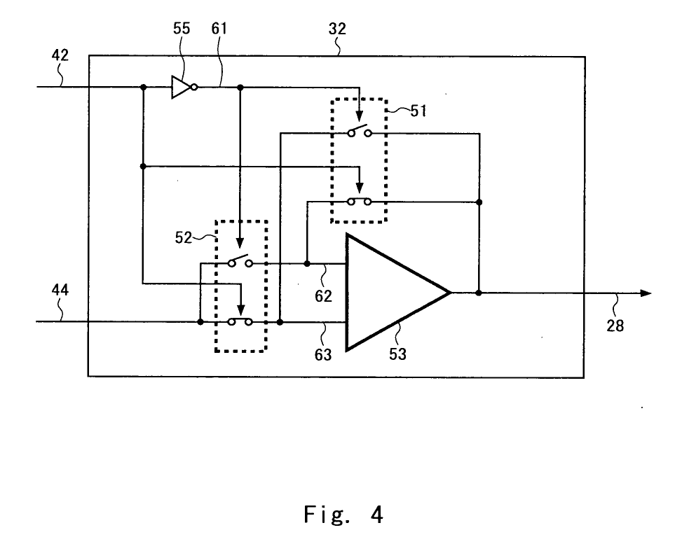

FIG. 4 shows a structure of the output buffer 32. The output buffer 32 includes a first differential selector switch 51, a second differential selector switch 52, and an output amplifier 53.

The first differential selector switch 51 receives the differential switch signal 42 that is output from the differential switch signal output device 31 (see, FIG. 3) and a reverse phase signal 61 whose phase is reverse to the differential switch signal 42 and which is converted by an inverter 55, and is constituted of two switches that are subjected to ON/OFF switch in reverse phases.

The second differential selector switch 52 receives the differential switch signal 42 and a reverse phase signal 61, and is constituted of two switches that are subjected to ON/OFF switch in reverse phases.

To the output amplifier 53, the gradation voltage signal 44 (see, FIG. 3) is input, and the output amplifier 53 outputs the drain signal to the drain signal line 28 and inputs the drain signal as a feedback signal. To the output amplifier 53, a first differential input signal line 62 and a second differential input signal line 63 are connected. Through which one of the first and second differential input signal lines 62 and 63 the gradation voltage signal 44 and the feedback signal (drain signal) are input is determined depending on the states of the first and second differential selector switches 51 and 52. For example, in the state shown in FIG. 4, the gradation voltage signal 44 is input through the second differential input signal line 63, and the feedback signal is input through the first differential input signal line 62.

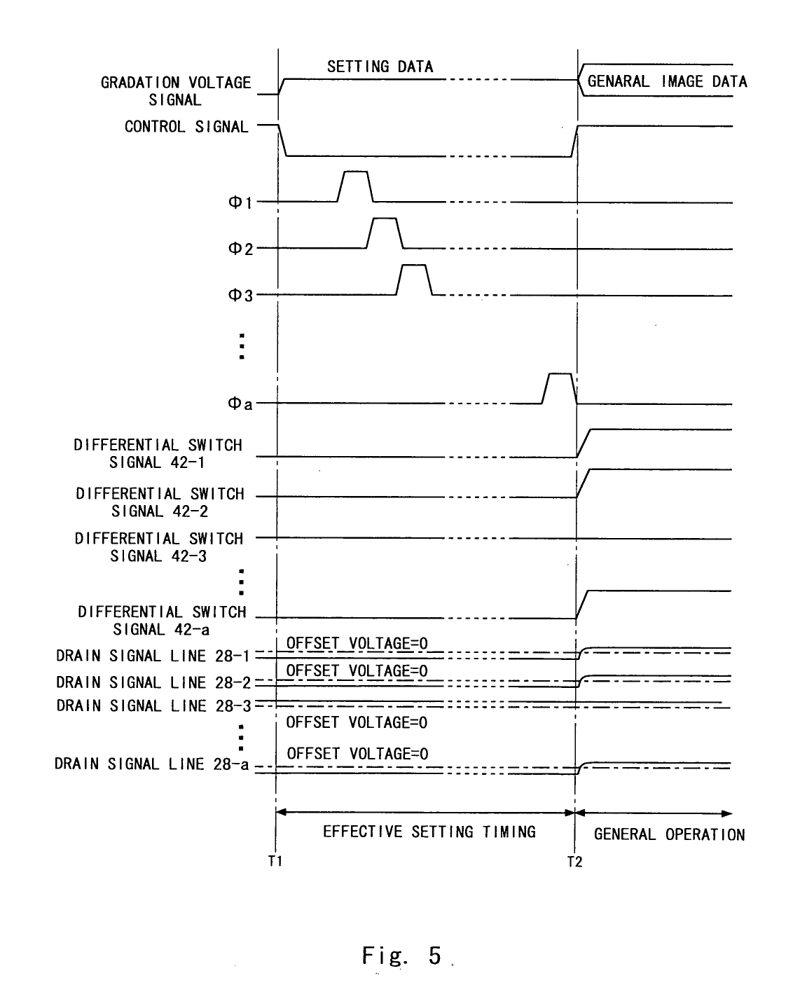

FIG. 5 shows a timing chart in the offset voltage control output circuit 20 having the structure described above. In effective setting timings between T1 and T2, first, at T1, the control signals are switched and the first and second differential selector switches 51 and 52 (see, FIG. 4) in the output buffer 32 are switched to the same direction. Further, the output selector switch 33 (see, FIG. 3) is brought into an OFF state, and the voltage of the gradation voltage signal 44 as setting data is set to be equal to the reference voltage 46.

Here, because the structures of all the output buffers 32 are the same, all differential switch signals 42-1, 42-2, 42-3, . . . , 42-a are switched to the same direction. At this time, the offset voltages of the drain signal lines 28-1, 28-2, 28-3, . . . , and 28-n are generated at random. In this example, the drain signal lines 28-1, 28-2, and 28-a each have the offset voltage on the lower side, and the drain signal line 28-3 has the offset voltage on the upper side.

Next, the control signals φ1 to φ a are sequentially set to “H”. Thus, when the output selector switch 33 is turned ON, the drain signal is set to be the compared voltage 45, and the compared voltage 45 is compared with the reference voltage 46 by the comparator 34.

Subsequently, in a case where the reference voltage 46 is larger than the compared voltage 45, if the comparator 34 is set so that the output signal becomes “H”, the differential switch reference information 41 (see, FIG. 3) is received by the differential switch signal output device 31 at a timing when the control signal φ1 is “L”.

At this time, in a case where the reference voltage 46 is smaller than the compared voltage 45, the differential switch reference information 41 is similarly received by the differential switch signal output device 31 at the timing when the control signal φ1 is “L”.

Finally, at a timing of T2, the control signals are switched, and values of the differential switch signals 42-1, 42-2, 42-3, . . . , and 42-a become effective, with the result that the directions of the drain signal lines 28-1, 28-2, 28-3, . . . , and 28-n are switched, and at the same time, general image data is input, shifting to a general operation. In this example, the offset voltages of the drain signal lines 28-1, 28-2, and 28-a are switched to the upper direction, and the offset voltage of the drain signal line 28-3 is not changed.

As described above, the differential switch signal output device 31 is set so that the differential switch signals 42-1, 42-2, 42-3, . . . , and 42-a are reversed in the case where the differential switch reference information 41 that is output from the comparator 34 is “H”, thereby switching the first and second differential selector switches 51 and 52 in the output buffer 32 only when the reference voltage 46 is larger than the compared voltage 45. As a result, it is possible to reverse the offset direction only for the output buffer 34 whose offset voltage is on the lower side. Therefore, all the offset voltages can be combined on the upper side. In addition, the directions of the offset voltages can be combined on the lower side in the same way.

Second Embodiment

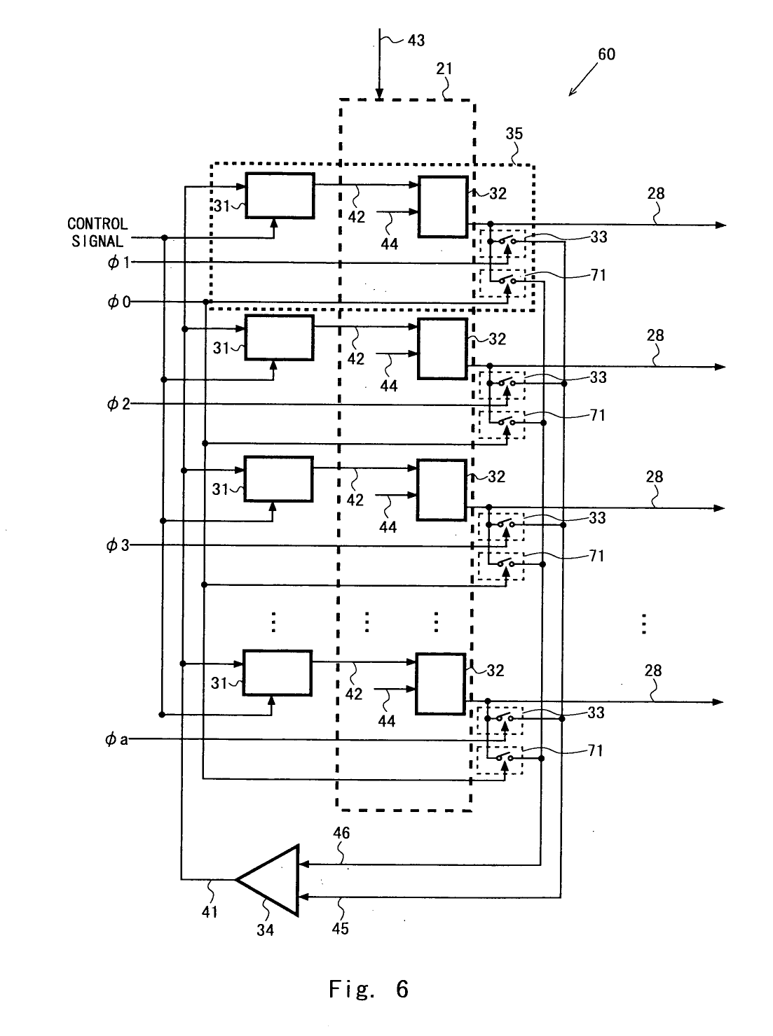

FIG. 6 is a diagram showing a structure of an offset voltage control output circuit 70 according to this embodiment. The offset voltage control output circuit 70 includes the differential switch signal output device 31, the output buffer 32, and the output selector switch 33, the comparator 34, and an output short circuiting switch 71.

The second embodiment is different from the first embodiment in that the output short circuiting switch 71 is provided in the second embodiment. One end of the output short circuiting switch 71 is connected to the drain signal line 28, and the other end thereof is connected to the comparator 34. The output short circuiting switch 71 is turned ON when the control signal φ0 is “H”. When the output short circuiting switch 71 is ON, the drain signal that is output from the output buffer 32 is input to the comparator 34 as the reference voltage 46.

That is, in the first embodiment, the image gradation voltage 43 is used as the reference voltage 46, while in this embodiment, an average voltage obtained by shorting all the outputs is used as the reference voltage.

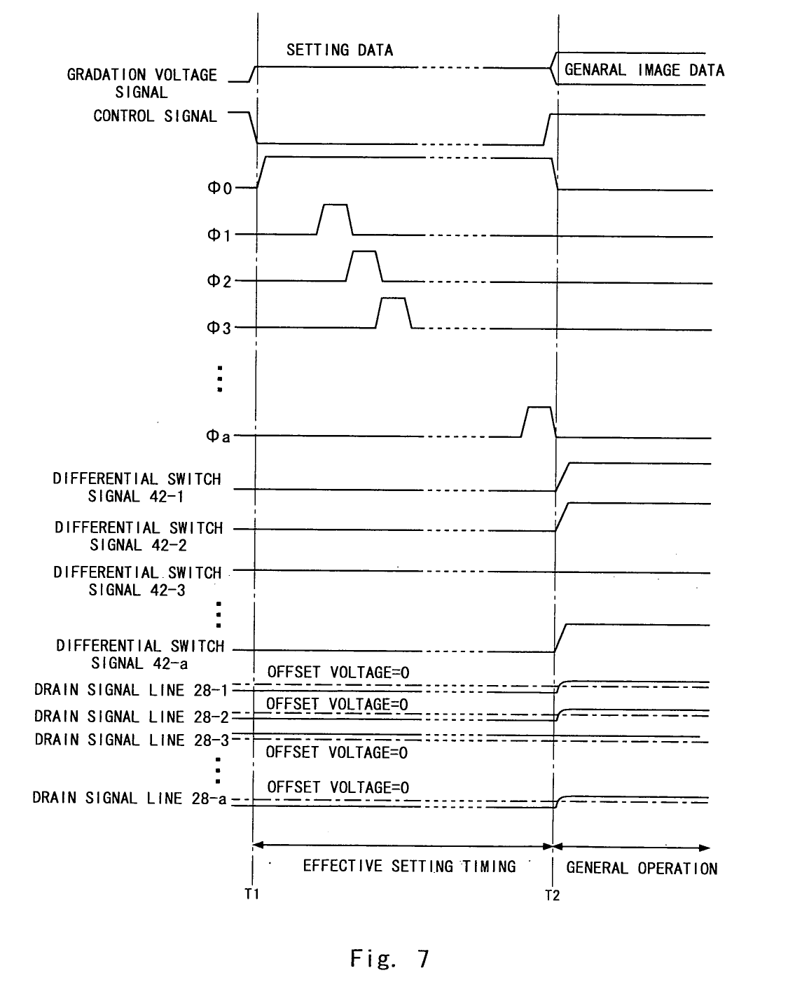

FIG. 7 shows a timing chart in the offset voltage control output circuit 70 having the structure described above. In the timing chart according to this embodiment, the control signal φ0 for driving the output short circuiting switch 71 is added to the timing chart (see, FIG. 5) according to the first embodiment. The other operations are the same as those of the first embodiment.

Third Embodiment

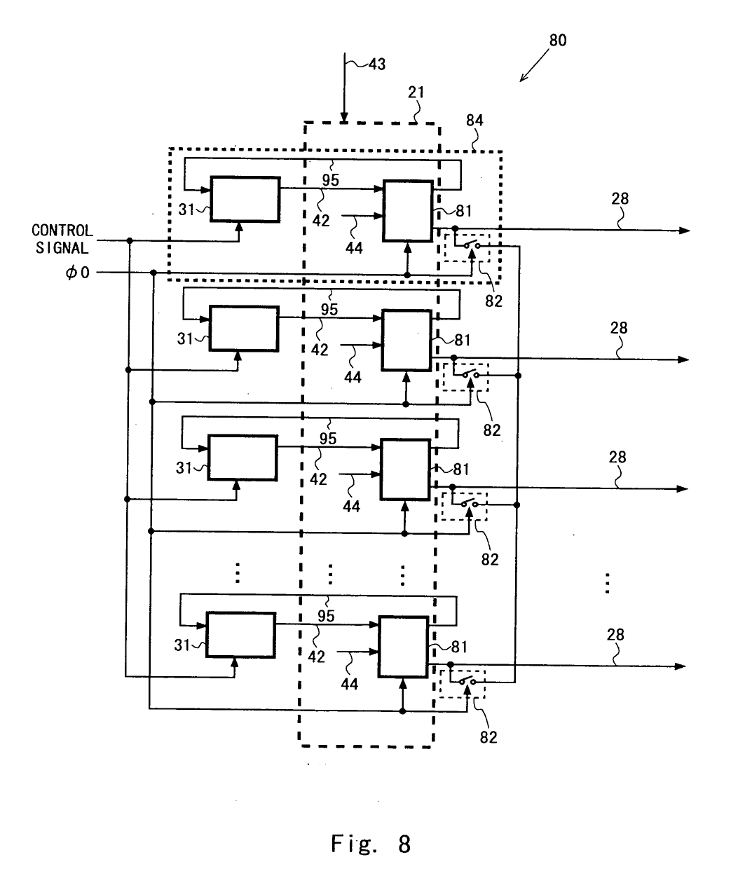

FIG. 8 shows a structure of an offset voltage control output circuit 80 according to this embodiment. The offset voltage control output circuit 80 includes the differential switch signal output device 31, an output buffer 81, and an output short circuiting switch 82.

The output buffer 81 and the output short circuiting switch 82 according to this embodiment have different structures from the output buffer 32 and the output short circuiting switch 71 according to the first or second embodiment, respectively. Further, the comparator 34 is not provided in this embodiment.

A part constituted of the differential switch signal output device 31, the output buffer 81, and the output short circuiting switch 82 is referred to as a drain signal line drive block 84.

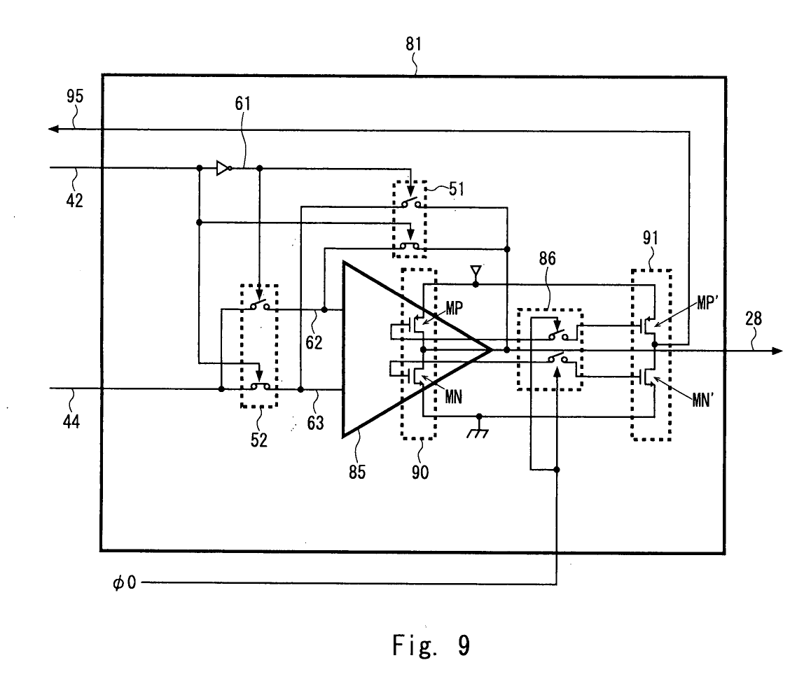

FIG. 9 shows a structure of the output buffer 81. The output buffer 81 includes the first differential selector switch 51, the second differential selector switch 52, an output amplifier 85, and a current detection selector switch 86, and a current judgment transistor 91.

The first and second differential selector switches 51 and 52 exert the same effects as in the first (and second) embodiment. To the output amplifier 85, the first differential input signal line 62 and the second differential input signal line 63 are connected. The drain signal that is output from the output amplifier 85 to the drain signal line 28 is fed back to the first differential selector switch 51.

The current detection selector switch 86 is connected to the gate electrodes of a P-MOS transistor (MP) and an N-MOS transistor (MN) of an output transistor 90 in the output amplifier 85, and is turned ON when the control signal φ0 is “H”.

The gate electrodes of a P-MOS transistor (MP′) and an N-MOS transistor (MN′) of the current judgment transistor 91 is connected to the current detection selector switch 86. Inverter outputs formed by the MP′ and the MN′ serve as differential switch reference information 95 to be input to the differential switch signal output device 31 (see, FIG. 8).

A ratio of the transistor sizes of the output transistor 90 and the current judgment transistor 91 has a relationship of MP:MN=MP′:MN′. The first and second differential selector switches 51 and 52 are switched by the differential switch signal 42 and the reverse phase signal 61 that are output from the differential switch signal output device 31 (see, FIG. 8).

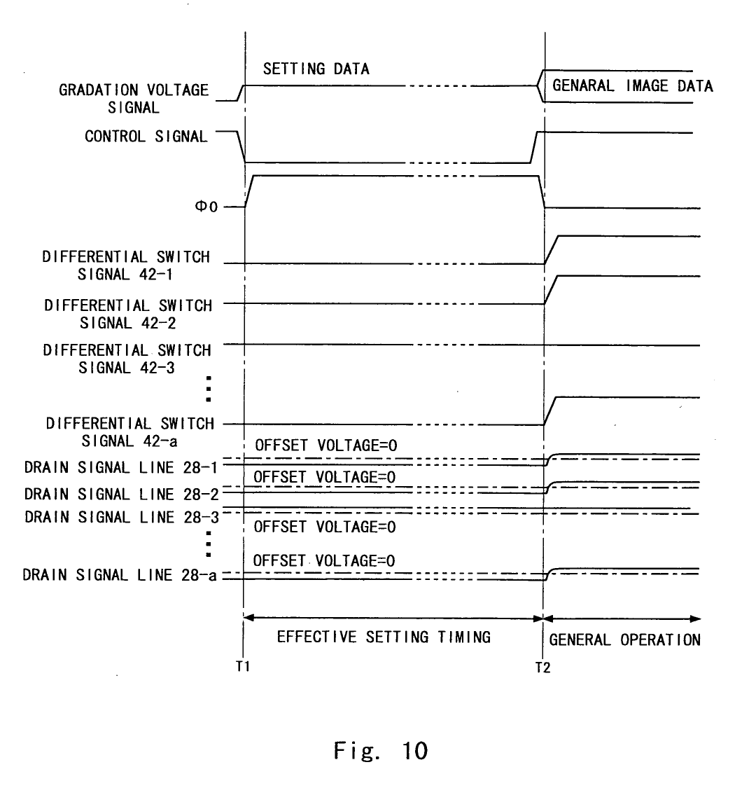

FIG. 10 shows a timing chart in the offset voltage control output circuit 80 having the structure described above.

In effective setting timings between T1 and T2, first, at the timing of T1, the control signals are switched and the first and second differential selector switches 51 and 52 (see, FIG. 9) in the output buffer 81 are switched to the same direction.

Here, because the structures of all the output buffers 81 are the same, all differential switch signals 42-1, 42-2, 42-3, . . . , 42-a are switched to the same direction. At this time, the offset voltages of the drain signal lines 28-1, 28-2, 28-3, . . . , and 28-n are generated at random. In this example, the drain signal lines 28-1, 28-2, and 28-a each have the offset voltage on the lower side, and the drain signal line 28-3 has the offset voltage on the upper side.

Next, at the timing of T1, the control signal φ1 is set to “H” and the output short circuiting switch 82 is turned ON, thereby short-circuiting all the drain signal lines 28-1, 28-2, 28-3, . . . , and 28-a. The voltage obtained by the short-circuiting is an average voltage of all the drain signal lines 28-1, 28-2, 28-3, . . . , and 28-a.

At this time, in a case where the voltage of the drain signal line drive block 84 (see, FIG. 8) is larger than the average voltage, a current flows from the drain signal line drive block 84 to the output short circuiting switch 82. On the other hand, in a case where the voltage of the drain signal line drive block 84 is smaller than the average voltage, a current flows from the output short circuiting switch 82 to the drain signal line drive block 84.

Next, with reference to FIG. 8, the operation in the output buffer 81 will be described. First, a description will be given on the state in which the current flows from the output buffer 81 to the output short circuiting switch 82. Generally, in an equilibrium state in which the output amplifier 85 does not perform charge and discharge, the currents that flow in the MP and the MN of the output transistor 90 are equal to each other. However, in a case where the current flows from the output buffer 81 to the output short circuiting switch 82, the balance between the currents that flow in the MP and the MN in the output amplifier 85 is lost, with the result that the MP current is larger than the MN current.

When the state in which the MP current is larger than the MN current is obtained, in the current judgment transistor 91 as a common gate electrode through the current detection selector switch 86, a state in which the MP′ current is larger than the MN′ current is also obtained.

The state in which the MP current is larger than the MN current is a state in which the differential switch reference information 95 is boosted up to the “H” side. Accordingly, when the state in which the current flows from the output buffer 81 is obtained, the differential switch reference information 95 becomes “H” and is input to the differential switch signal output device 31.

In a state in which the current flows from the output short circuiting switch 82 to the output buffer 81, operations opposite to the state in which the MP current is larger than the MN current are performed, and therefore the differential switch reference information 95 becomes “L” and is input to the differential switch signal output device 31.

As described above, according to this embodiment, the differential switch reference information 95 can also be determined to be “H” or “L” depending on the directions of the offset voltages as in the first and second embodiments.

Finally, at a timing of T2 in FIG. 10, the control signal is switched, and values of the differential switch signals 42-1, 42-2, 42-3, . . . , and 42-a are set to be effective, with the result that the directions of the drain signal lines 28-1, 28-2, 28-3, . . . , and 28-a are switched, shifting to a general operation.

As described above, according to this embodiment, the comparator can be eliminated, and the output voltage does not have to be switched for each output.

Further, in the first to third embodiments, when the differential switch signal output device 31 is formed of a non-volatile memory circuit, products in which the directions of the offset voltages are the same direction can be selected and shipped.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A liquid crystal display device comprising:
an image signal line drive unit that supplies an image voltage depending on an output image to a plurality of image signal lines set in a matrix pattern on a liquid crystal panel constituted of a plurality of pixels;
an offset direction detection unit that detects offset directions of offset voltages on the plurality of image signal lines; and
an offset direction combination unit that collectively combines the offset directions of the offset voltages of the plurality of image signal lines into one direction based on the offset directions.

2. The liquid crystal display device according to claim 1, further comprising:
a differential switch signal output device that outputs a differential switch signal based on a control signal for controlling a timing at which the image voltage is supplied and a differential switch reference signal;
an output buffer that outputs the image voltage based on the differential switch signal and a gradation voltage signal;
an output selector switch that is connected to each of the plurality of image signal lines and controlled by a control signal that allows separate ON/OFF control for each; and
a comparator to which an image gradation voltage is input as a reference voltage and to which the image voltage is input as a compared voltage with the output selector switch being ON, to output the differential switch reference signal generated based on the reference voltage and the compared voltage to the differential switch signal output device.

3. The liquid crystal display device according to claim 2, wherein the output buffer comprising:
a first differential selector switch constituted of two switches that are subjected to ON/OFF switch in phases reversed to each other based on the differential switch signal that is output from the differential switch signal output device and a reverse phase signal of the differential switch signal,
a second differential selector switch constituted of two switches that are subjected to ON/OFF switch in phases reversed to each other based on the differential switch signal that is output from the differential switch signal output device and a reverse phase signal of the differential switch signal, and
an output amplifier to which the first differential selector switch and the second differential selector switch are connected, and to which the gradation voltage signal and a feedback signal of the image voltage are selectively input depending on states of the first and second differential selector switches, to output the image voltage.

4. The liquid crystal display device according to claim 1, further comprising:
a differential switch signal output device that outputs a differential switch signal based on a control signal for controlling a timing at which the image voltage is supplied and a differential switch reference signal;
an output buffer that outputs the image voltage based on the differential switch signal and a gradation voltage signal;
an output selector switch that is connected to each of the plurality of image signal lines and controlled by a control signal that allows separate ON/OFF control for each;
an output short circuiting switch that is connected to each of the plurality of image signal lines and controlled by a control signal that allows collective ON/OFF control at the same time; and
a comparator to which a reference voltage and a compared voltage are input selectively based on ON/OFF of the output selector switch and the output short circuiting switch, to output the differential switch reference signal generated based on the reference voltage and the compared voltage to the differential switch signal output device.

5. The liquid crystal display device according to claim 4, wherein the output buffer according to claim 3.

6. The liquid crystal display device according to claim 1, further comprising:
a differential switch signal output device that outputs a differential switch signal based on a control signal for controlling a timing at which the image voltage is supplied and a differential switch reference signal;
an output buffer that outputs the image voltage to the plurality of image signal lines based on the differential switch signal and a gradation voltage signal, and outputs a feedback signal of the image voltage to the differential switch signal output device as the differential switch reference signal; and
an output short circuiting switch that is connected to each of the plurality of image signal lines and controlled by a control signal that allows collective ON/OFF control at the same time.

7. The liquid crystal display device according to claim 6, wherein the output buffer comprising:
a first differential selector switch constituted of two switches that are subjected to ON/OFF switch in phases reversed to each other based on the differential switch signal that is output from the differential switch signal output device and a reverse phase signal of the differential switch signal,
a second differential selector switch constituted of two switches that are subjected to ON/OFF switch in phases reversed to each other based on the differential switch signal that is output from the differential switch signal output device and a reverse phase signal of the differential switch signal,
an output amplifier to which the first differential selector switch and the second differential selector switch are connected, and to which one of the gradation voltage signal and the feedback signal of the image voltage is selectively input depending on states of the first and second differential selector switches, to output the image voltage,
a current detection selector switch that is connected to gate electrodes of a P-MOS transistor (MP) and an N-MOS transistor (MN) of an output transistor in the output amplifier, and subjected to ON/OFF control in synchronization with the control signal that controls the output short circuiting switch, and
a current judgment transistor in which gate electrodes of a P-MOS transistor (MP′) and an N-MOS transistor (MN′) are connected to the current detection selector switch, and that sets an inverter output formed by the MP′ and MN′ to be the differential switch reference signal that is input to the differential switch signal output device, wherein the output transistor and the current judgment transistor have a relationship of MP:MN=MP′:MN′ in sizes of the transistors.

8. A flicker prevention method for a liquid crystal display device, comprising:
detecting offset directions of offset voltages on a plurality of image signal lines which are set in a matrix pattern on a liquid crystal panel constituted of a plurality of pixels, and to which an image voltage depending on an output image is supplied; and
combining the offset directions of the offset voltages of all the image signal lines into the same direction based on the offset directions.
